(19) United States
(12) Patent Application Publication
(10) Pub. No.: US 2026/0267343 A1
(43) Pub. Date: Sep. 10, 2026

(54) Ascertaining at Least One Border for Operating a Robot

(71) Applicants: KUKA Deutschland GmbH, Augsburg (DE); KUKA Systems GmbH, Augsburg (DE)

(72) Inventors: Juergen Blume, Friedberg (DE); Ingo Kresse, Augsburg (DE); Pascal Caprano, Augsburg (DE); Marcus Hofmann, Seesen (DE); Fabian Jennrich, Muenchen (DE)

(73) Assignees: KUKA Deutschland GmbH, Augsburg (DE); KUKA Systems GmbH, Augsburg (DE)

(21) Appl. No.: 18/847,039

(22) PCT Filed: Mar. 13, 2023
(86) PCT No.: PCT/EP2023/056356

§ 371 Date: Sep. 13, 2024

(30) Foreign Application Priority Data
Mar. 15, 2022 (DE) 10 2022 202 562.8
Mar. 15, 2022 (DE) 10 2022 202 563.6
Mar. 15, 2022 (DE) 10 2022 202 564.4
Mar. 15, 2022 (DE) 10 2022 202 569.5
Mar. 15, 2022 (DE) 10 2022 202 571.7

(51) Int. Cl. G05D 1/622; G05D 1/224; G05D 1/65; G05D 1/689; G05D 109/10; G05D 111/10; G05D 111/20; G05D 111/30

(52) U.S. Cl. CPC G05D 1/622; G05D 1/2249; G05D 1/65; G05D 1/689; G05D 2109/10; G05D 2111/17; G05D 2111/20; G05D 2111/30

(57) ABSTRACT

A method for ascertaining at least one border for operating a robot includes detecting data of real surroundings of the robot using a detection device, in particular a mobile detection device, in particular a portable detection device; ascertaining a first surroundings contour on the basis of said detected data; and ascertaining a first border of a first spatial area to be monitored on the basis of the ascertained first surroundings contour.

### CROSS-REFERENCE TO RELATED APPLICATIONS

This application is a national phase application under 35 U.S.C. § 371 of International Patent Application No. PCT/EP2023/056356, filed Mar. 13, 2023 (pending), which claims the benefit of priority to German Patent Application Nos. DE 10 2022 202 562.8, DE 10 2022 202 563.6, DE 10 2022 202 564.4, DE 10 2022 202 569.5, and DE 10 2022 202 571.7, each filed Mar. 15, 2022; and is related to U.S. patent application Ser. No. ______ (Attorney Docket No. KUKAR-188), U.S. patent application Ser. No. ______ (Attorney Docket No. KUKAR-189), U.S. patent application Ser. No. ______ (Attorney Docket No. KUKAR-190), and U.S. patent application Ser. No. ______ (Attorney Docket No. KUKAR-192), each filed Sep. 13, 2024, the disclosures of which are incorporated by reference herein in their entirety.

### TECHNICAL FIELD

The present invention relates to a method for ascertaining at least one border for operating a robot and to a computer program or computer program product for carrying out the method.

### BACKGROUND

During operation, robots are monitored according to internal company practice for exceeding specified borders, for example, whether the robot enters a (prohibited) protection area or leaves a (permitted) work area.

According to internal company practice, these borders are currently set manually.

### SUMMARY

The object of the present invention is to improve the operation of robots.

This object is achieved by a method, a system, or a computer program or computer program product for carrying out a method as described herein.

According to an embodiment of the present disclosure, a method for ascertaining at least one border for operating a robot comprises the steps of:
detecting data of real surroundings of the robot using a detection device that is mobile in one embodiment, in particularly portable by a person in a further development;
ascertaining a first surroundings contour on the basis of said detected data; and
ascertaining a first border of a first spatial area to be monitored on the basis of the ascertained first surroundings contour.

In one embodiment of the present invention, the method comprises the steps of:
monitoring the robot for exceeding this ascertained first border during operation of the robot; and
switching to a first operating mode of the robot if exceeding the first border is detected.

By using the detection device or data detected thereby to ascertain at least one surroundings contour and a border on the basis of the detected surroundings contour-ascertained on the basis of the detected real surroundings and then monitoring it in an embodiment of the present invention, the monitoring can be implemented (more) quickly and/or (more) precisely and/or carried out (more) reliably in one embodiment. In one embodiment, the robot moves during the operation or an operation of the robot and/or runs a stored work program.

In one embodiment, the method comprises the step of:
ascertaining a second border of a second spatial area on the basis of the first surroundings contour, preferably such that the second border has a different position and/or a different, in particular minimum, maximum and/or average, distance to the first surroundings contour than the first border;
and in a further development, the steps of:
   monitoring the robot for exceeding this ascertained second border during operation of the robot; and
   switching to a second operating mode of the robot if exceeding this second border is detected.

As a result, in one embodiment, it is possible to react in several stages to borders being (successively) exceeded, or to ascertain suitable borders for this, for example the robot can issue a warning signal and/or be regulated (more) flexibly when a first, narrower border of a permissible work area is exceeded and can be stopped when a second, further border of the work area is exceeded, or can issue a warning signal and/or be regulated (more) flexibly when a first, further border of a prohibited protection area is exceeded, and can be stopped when a second, narrower border of the protection area is exceeded. If the same (first) surroundings contour is used to ascertain the first and second borders, concentric borders can be monitored in one embodiment. In one embodiment, one of the first and second spatial areas contains the other of the first and second spatial areas in whole or in part.

Additionally or alternatively, the method in one embodiment comprises the step of:
ascertaining a second border of a second spatial area on the basis of a second surroundings contour, wherein this second surroundings contour is (also) ascertained (in a step of the method) on the basis of the detected data;
and in a further development, the steps of:
   monitoring the robot for exceeding this ascertained second border during operation of the robot; and
   switching to a second operating mode of the robot if exceeding this second border is detected.

As a result, in one embodiment, areas spatially at a distance from each other can be monitored in parallel, or suitable borders can be ascertained for this purpose, for example a protection area in the proximity of an entrance to a robot cell into which the robot may not enter, and an interaction area in which the robot may interact with people and is accordingly operated for this purpose, for example moved (more) slowly and/or regulated (more) flexibly. In one embodiment, the first and second spatial areas are separated from each other, in a further development spatially at a distance from each other and/or assigned to different areas of the real surroundings. In one embodiment, the first and second surroundings contours are separate from each other, in a further development spatially at a distance from each other and/or assigned to different areas of the real surroundings. In one embodiment, the first and/or second surroundings contour (each) has at least one corner, line, edge and/or area, in particular surface, and can in particular be such. This allows the real surroundings to be taken into account particularly advantageously in one embodiment.

In a further development of one of the above-mentioned embodiments, the first and second borders are separate from each other, in a further development, spatially at a distance from each other and/or assigned to different areas of the real surroundings. A spatial area within the meaning of the present invention can be (completely) closed, in particular a polyhedron, in particular a prism, in particular a cuboid, a cylinder, cone, ellipsoid, in particular a sphere, or the like. Likewise, a spatial area within the meaning of the present invention can also be partially open, for example a half-space or the like. In one embodiment, the first and/or second border completely encloses the (respective) spatial area. This allows a particularly high reliability to be achieved in one embodiment. In one embodiment, the first and/or second border does not completely enclose the (respective) spatial area. This can simplify the determination and/or monitoring of the border in one embodiment. The terms “first” and “second” used here serve only for better identification, without any limitation of generality.

In one embodiment, the first surroundings contour and/or the second surroundings contour is (each) ascertained with the aid of at least one approximation of features detected with the aid of the detection device, in particular points, particularly preferably a point cloud detected with the aid of the detection device, in a further development with the aid of one or more grids and/or one or more approximation surfaces, in particular flat approximation surfaces and/or singly or multiply curved approximation surfaces, wherein such grids or approximation surfaces in one embodiment are ascertained by compensation, in particular interpolation or extrapolation, smoothing and/or other fitting functions of features, in particular points, detected by means of the detection device; in particular, the first surroundings contour and/or the second surroundings contour can have, in particular be, the (respective) approximation. By means of such an approximation, the surroundings can be taken into account in a particularly advantageous manner, in particular quickly and/or precisely.

In one embodiment, the first border and/or the second border is (each) ascertained on the basis of a user input, in a further development on the basis of a user selection from suggested, particularly preferably visualized in an augmented reality (virtual representations of), surroundings contours and/or borders.

In one embodiment, a user is provided with a selection of various surroundings contours, each of which is or has been ascertained on the basis of the recorded (data of the) real surroundings, in a further development in the form of virtual representations of the surroundings contours in an augmented reality, and the user can select one or more of these surroundings contours, on the basis of which the respective border is then ascertained. Likewise, in one embodiment, a user can also be provided with a choice of different borders, each of which is or has been ascertained on the basis of the recorded (data of the) real surroundings and the surroundings contours ascertained on this basis, in a further development in the form of virtual representations of the borders in an augmented reality, and the user can select one or more of these borders which are then monitored in one embodiment.

In this way, the user can specify desired areas for monitoring (more) quickly and/or reliably in one embodiment, wherein the selection of the surroundings contours in one embodiment can enable advantageous, in particular (more) precise and/or (more) homogeneous, demarcation, and the selection of the borders themselves in one embodiment advantageously can enable borders (more) adapted to the situation.

Additionally or alternatively, the first border and/or the second border in one embodiment is (each) ascertained on the basis of a specified position and/or a specified distance from the surroundings contour on the basis of which the (respective) border is or has been ascertained, wherein in a further development, the position or the distance can be or is (variably) specified on the basis of a user input and/or the distance is a constant distance. A position within the meaning of the present invention in an embodiment defines a one-, two-, or three-dimensional position and/or a one-, two-, or three-dimensional orientation.

In this way, in one embodiment, the (respective) border can advantageously be ascertained automatically and/or the user can adapt it to the respective border conditions, for example different safety requirements, process conditions or the like. For example, for a protection area that prevents a collision with a known surroundings, a smaller (safety) distance between the border and the surroundings contour can be specified than for a protection area that is intended to keep a movement corridor clear, since there is a greater uncertainty in this case.

In one embodiment, the specified distance of the first border and/or the second border to the surroundings contour on the basis of which the (respective) border is ascertained is greater than zero. In one design, this surroundings contour can be particularly effectively protected from contact with the robot.

In one embodiment, the specified distance of the first border and/or the second border to the surroundings contour on the basis of which the (respective) border is ascertained is equal to zero, or the border and the surroundings contour are at least partially identical. In one embodiment, this surroundings contour can itself function as a border and, for example, be used for planned approaching or contacting the surroundings, especially this surroundings contour.

In one embodiment, the robot is stopped in the first operating mode, in a further development by continuing to travel along a specified, in particular already partially traveled, path or in a path-true manner and/or with or without subsequent disconnection of a power supply before reapproaching, in another development by deviating from a specified, in particular already partially traveled, path, or not in a path-true manner and/or with or without subsequent disconnection of a power supply before reapproaching, or the first border therefor is ascertained. In another embodiment, the robot is (further) moved in the first operating mode at a changed, preferably reduced, speed, in a further development while continuing to travel along a specified, in particular already partially traveled, path or in a path-true manner, in another development while deviating from a specified, in particular already partially traveled, path or not in a path-true manner, or the first border therefor is ascertained.

Additionally or alternatively, in one embodiment the robot is stopped in the second operating mode, in a further development by continuing to travel along a specified, in particular already partially traveled, path or in a path-true manner and/or with or without subsequent disconnection of a power supply before reapproaching, in another development by deviating from a specified, in particular already partially traveled, path or not in a path-true manner and/or with or without subsequent disconnection of a power supply before reapproaching, or the second border for this is ascertained. In another embodiment, the robot is (further) moved in the second operating mode at a changed, preferably reduced, speed, in a further development while continuing to travel along a specified, in particular already partially traveled, path or in a path-true manner, in another development while deviating from a specified, in particular already partially traveled, path or not in a path-true manner, or the second border for this is ascertained.

By stopping and/or disconnecting the power supply, in one embodiment, there can be a particularly safe reaction to exceeding border by the robot; by changing, in particular reducing, the speed and/or maintaining the power supply, a disruption of work mode can be reduced.

In one embodiment, in particular, in the first operating mode, a changed behavior of the robot is specified in the event of a collision, or the first border therefor is ascertained. Additionally or alternatively, in particular, in one embodiment in the second operating mode, a changed behavior of the robot is specified in the event of a collision, or the second border therefor is ascertained. Such a modified behavior of the robot in the event of a collision can, for example, include a modified, preferably increased, control compliance, a preferably modified withdrawal path or the like.

In this way, safety can be increased in one embodiment and/or there can be a particularly advantageous response in a human-robot collaboration.

In one embodiment, an optical and/or acoustic warning signal is emitted as a result of switching to the first operating mode and/or as a result of switching to the second operating mode; in a further development, different signals are emitted by the robot and/or as a result of switching to the first operating mode and to the second operating mode, or the first or second border therefor is ascertained.

In this way, safety can be increased in one embodiment and/or there can be a particularly advantageous response in a human-robot collaboration.

In one embodiment, a virtual representation of the first border and/or a virtual representation of the second border is visualized using a visualization device in an augmented reality.

This allows the ascertained border(s) to be advantageously selected and/or checked in one embodiment.

In one embodiment, the detection device is arranged on the visualization device, in a further development integrated or detachable.

As a result, in one embodiment, a detection device of an AR system can advantageously be used.

In one embodiment, with the aid of the visualization device is (also) a virtual representation of the robot and/or a path of the robot in the augmented reality is visualized.

This allows the ascertained border(s) to be selected and/or checked very advantageously in one embodiment.

In one embodiment, the visualization device is a mobile, in particular portable (by a person, preferably with one hand), visualization device, in one embodiment it has a handheld device, preferably a handheld, tablet, smartphone, laptop or the like, and/or glasses, in particular A(ugmented)R(eality) glasses. In one embodiment, the detection or visualization device (hardware and/or software) is set up to control the robot or is (also) used for this purpose.

This means that startup can be carried out (more) quickly and/or safely in one embodiment.

In one embodiment, the detection device for detecting the data is moved translationally and/or rotationally and/or manually relative to the real surroundings.

This allows a larger area of the surroundings and/or the surroundings to be detected (more) precisely in one embodiment, and operation can therefore be better monitored.

In one embodiment, the detection device has one or more contact-free measuring distance meters, in a further development one or more radar distance meters, one or more ultrasonic distance meters and/or one or more lidar distance meters. In one embodiment, this allows the surroundings to be recorded (more) precisely and therefore operation to be monitored particularly advantageously, in particular (more) precisely and/or without interference. Lidar distance meters are particularly advantageous because they are compact and measure precisely.

Additionally or alternatively, the detection device in one embodiment has one or more cameras, in a further development a 3D camera system which in one embodiment has at least two or stereo cameras, a triangulation system in which at least one light source images a defined pattern onto the surroundings and at least one camera records this pattern, preferably from a different angle, at least one TOF camera, at least one interferometry camera, at least one light field camera or the like, and/or image evaluation. In one embodiment, this allows the surroundings to be recorded (more) quickly, and therefore the method can be carried out particularly quickly, and/or larger surroundings can be taken into account.

In one embodiment, the robot is monitored for exceeding the ascertained first border and/or for exceeding the ascertained second border based on detected joint positions (of the robot) and/or a computer-implemented model of the robot.

This means that monitoring can be particularly reliable and/or precise in one embodiment.

The first and/or second border is or will be specified or defined in one embodiment in the joint (coordinate) space of the robot and/or stored in the form of joint coordinate borders or areas. This means that monitoring can be carried out particularly reliably and/or quickly in one embodiment. In one embodiment, the first and/or second border in the workspace of the robot is or will be specified or defined, in particular for a robot-fixed reference, for example the TCP or a member of the robot, and/or a virtual shell of the robot, and/or stored in the form of workspace coordinate borders or areas. In one embodiment, this allows borders to be adapted to the surroundings in a particularly intuitive and/or reliable manner. In this case, in a further development, the ascertained joint positions are transformed on the basis of a computer-implemented model of the robot into a corresponding position and/or orientation of one or more robot-fixed references or into a corresponding shape, position and/or orientation of the virtual shell and the exceeding of the border(s) ascertained for this purpose is monitored. In one embodiment, to monitor or while monitoring the robot for exceeding the first and/or second border, it is checked whether a virtual shell of the robot exceeds this border, wherein in one embodiment, this virtual shell is ascertained on the basis of the computer-implemented model of the robot or is defined thereby.

In one embodiment, the first border and/or the second border is/are (each) ascertained on the basis of one or more three-dimensional geometry primitives which (each) has a specified relation, in particular spatial position, to the first or second surroundings contour; in a further development, the border is a surface of the geometry primitive(s) or a part thereof. Additionally or alternatively, the virtual shell can also be ascertained on the basis of one or more three-dimensional geometry primitives, wherein the or each geometry primitive has a specified relation, in particular spatial position, to a member of the robot.

A geometry primitive within the meaning of the present invention is, in one embodiment, polyhedron, in particular prism, in particular a cuboid, or a cylinder, cone, ellipsoid, in particular a sphere, or the like. This means that monitoring can be implemented particularly quickly and/or reliably in one embodiment.

In one embodiment, the monitoring can thereby be carried out (more) quickly and/or (more) reliably.

In one embodiment, the robot has a robot arm with three or more, preferably at least six, in one embodiment at least seven, joints, in a further development rotary joints, which connect movable members of the robot to one another and are movable by drives, in particular motors, of the robot, and/or a mobile base, in particular movable with the aid of at least one drive, in particular motor, of the robot. The invention is particularly advantageous for such robots, in particular because of the complex movements thereby enabled. In one embodiment, a robot-guided tool or workpiece forms a (distal) movable member of the robot within the meaning of the present invention. Accordingly, in one embodiment, also or only a robot-guided tool or workpiece, preferably a virtual shell which has a specified relation, in particular spatial position, thereto, is monitored for exceeding the first and/or second border (by the tool or workpiece or the virtual shell). Since such a tool or workpiece often covers the longest distances, this can realize particularly advantageous, in particular meaningful and/or fast, monitoring.

In one embodiment, the first and/or second surroundings contour is ascertained on the basis of the robot, in particular with the aid of data of the robot detected, in particular by the detection device, and/or on the basis of a computer-implemented model of the robot. In a further development, the robot, which may also be recorded when data from the real surroundings of the robot is detected using the detection device, is at least partially eliminated or hidden. In one embodiment, this can improve the environment model.

In one embodiment, the first and/or second surroundings contour is detected based on a specification of an area of the surroundings to be ascertained by a user. In a further development, an area of surroundings excluded by the user is not detected by means of the detection device or is excluded, in particular ignored, when ascertaining the first and/or second surroundings contour, and/or only an area of surroundings specified by the user is detected with the aid of the detection device, or is taken into account, in particular evaluated, when ascertaining the first and/or second surroundings contour. In one embodiment, this allows the first or second surroundings contour to be ascertained (more) quickly and/or (more) precisely.

According to one embodiment of the present disclosure, a system, in particular in terms of hardware and/or software, in particular in terms of programming, is configured to carry out a method described herein and/or comprises:
a, in particular mobile, in particular portable, detection device for detecting data of a real surroundings of the robot;
means for ascertaining a first surroundings contour based on these detected data; and
means for ascertaining a first border of a first spatial area to be monitored on the basis of this ascertained first surroundings contour.

In an embodiment, the system or its means comprises:
means for monitoring the robot for exceeding this ascertained first border during operation of the robot and means for switching to a first operating mode of the robot if exceeding of the first border is detected; and/or
means for ascertaining a second border of a second spatial area on the basis of the first surroundings contour or a second surroundings contour ascertained on the basis of the acquired data, in particular means for monitoring the robot for exceeding this ascertained second border during operation of the robot, and means for switching to a second operating mode of the robot if exceeding the second border is detected; and/or
means for ascertaining the first and/or second surroundings contour using at least one approximation of features detected by the detection device, in particular points; and/or
means for ascertaining the first and/or second border on the basis of a user input, in particular user selection from suggested surroundings contours and/or borders, and/or on the basis of a specified position and/or a specified distance from the surroundings contour on the basis of which the border is ascertained; and/or
means for stopping or moving the robot at a changed, in particular reduced, speed in the first and/or second operating mode; and/or
means for outputting an optical and/or acoustic warning signal as a result of the switching, in particular by the robot; and/or
a visualization device for visualizing a virtual representation of the first and/or second border in an augmented reality, in particular for visualizing a virtual representation of the robot and/or a path of the robot in the augmented reality; and/or
at least one contact-free measuring distance meter, in particular at least one lidar, radar or ultrasonic distance meter, and/or at least one camera, in particular a 3D camera system, and/or image evaluation; and/or
means for monitoring the robot on the basis of detected joint positions and/or a computer-implemented model of the robot for exceeding the ascertained first border and/or for exceeding the ascertained second border; and/or
means for ascertaining the first and/or second border on the basis of at least one three-dimensional geometry primitive which has a specified relation, in particular spatial position, to the first or second surroundings contour; and/or
means for ascertaining the first and/or second surroundings contour on the basis of the robot, in particular with the aid of data of the robot detected, in particular by the detection device, and/or on the basis of a computer-implemented model of the robot, and/or on the basis of a specification of an area of surroundings to be detected by a user.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to output output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit is able to carry out the steps of such methods and therefore, in particular, is able to detect the borders or operate the robot. In an embodiment, a computer program product may comprise, in particular be, a, in particular computer-readable and/or non-volatile, storage medium for storing a program or instructions or with a program stored thereon or with instructions stored thereon. In an embodiment, execution of said program or said instructions by a system or controller, in particular a computer or an arrangement of a plurality of computers, causes the system or controller, in particular the computer(s), to carry out a method described herein or one or more steps thereof, or the program or instructions are configured to do so.

In an embodiment, one or more, in particular all, steps of the method are implemented completely or partially automatically, in particular by the system or its means.

In one embodiment, the system comprises the robot. In one embodiment, the method also comprises operating the robot, and can therefore in particular be a method for operating a or the robot. Accordingly, the system in one embodiment can also be a system for operating a or the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system according to an embodiment of the present disclosure; and

FIG. 2 illustrates a method according to an embodiment of the present disclosure.

### DETAILED DESCRIPTION

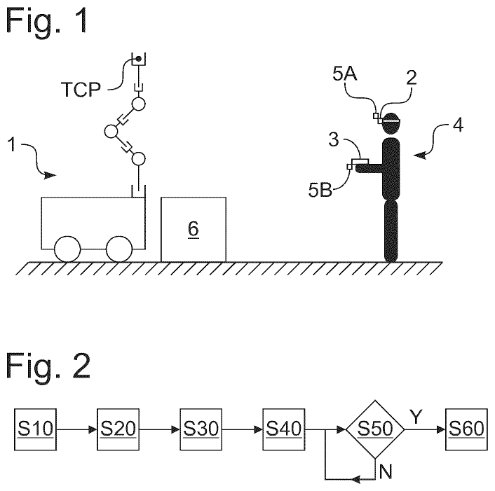

FIG. 1 shows a system for operating a robot 1.

In one embodiment, a user 4 wears a visualization device in the form of AR glasses 2 or a tablet 3.

In a step S10 (see FIG. 2), a real surroundings 6 of the robot is ascertained using a detection device 5A or 5B arranged on the visualization device 2 or 3, preferably integrated or detachable, for example a 3D camera system, lidar sensor or the like, and in a step S20, a first surroundings contour is ascertained using this data.

In a step S30, a first border is ascertained on the basis of this first surroundings contour, which has a distance from the first surroundings contour that can be specified or is specified by the user 4.

In a step S40, a virtual representation of the first border is visualized using the visualization device 2 or 3 in an augmented reality, in which, in a further development, a virtual representation of the robot is also visualized while traveling along a specified path. This allows the user to advantageously check the first border. In one embodiment, the user is offered a choice of several initial borders, in a further embodiment in the form of virtual representations of these borders, and the user selects one of these borders. Additionally or alternatively, in one embodiment he can specify a desired distance of the border from the surroundings contour.

In a step S50, the robot is monitored during its operation for exceeding this first border.

If exceeding the first border has been detected (S50: “Y”), a step S60 is switched to in a first operating mode of the robot in which it, for example, issues a warning signal and/or stops; otherwise (S50: “N”) the monitoring continues.

Although exemplary embodiments have been explained in the preceding description, it is pointed out that a large number of modifications is possible.

For example, in steps S20, S30, one or more second surroundings contours and/or borders can be ascertained, in step S40 (their virtual representation(s)) can be visualized in the augmented reality and, if necessary, selected by the user from among them, and/or their desired distance can be specified, and in step S50 the robot can be monitored during its operation for exceeding these second borders or switched to a corresponding second operating mode in step S60.

It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### List of Reference Signs

1 Robot
2 AR glasses
3 Tablet
4 User
5A; 5B Detection device
6 Surroundings
TCP Tool center point

What is claimed is:

1-17. (canceled)

18. A method for ascertaining at least one border for operating a robot, the method comprising:
detecting data of real surroundings of the robot using a detection device, in particular a mobile or portable detection device;
ascertaining a first surroundings contour on the basis of the detected data;
ascertaining a first border of a first spatial area to be monitored on the basis of the ascertained first surroundings contour;
monitoring the robot for exceeding the ascertained first border during operation of the robot; and
switching operation of the robot to a first operating mode of the robot in response to a detection that the first border is exceeded.

19. The method of claim 18, further comprising:
ascertaining a second border of a second spatial area based on the first surroundings contour or a second surroundings contour ascertained on the basis of the detected data.

20. The method of claim 19, further comprising:
monitoring the robot for exceeding the ascertained second border during operation of the robot; and
switching to a second operating mode of the robot in response to a detection that the second border is exceeded.

21. The method of claim 19, wherein at least one of the first surroundings contour or the second surroundings contour is ascertained with the aid of at least one approximation of features detected with the aid of the detection device.

22. The method of claim 21, wherein features detected with the aid of the detection device are points of the real surroundings.

23. The method of claim 19, wherein at least one of the first border or the second border is ascertained based on at least one of:
a user input; or
at least one of a specified position or a specified distance from the surroundings contour.

24. The method of claim 23, wherein the user input comprises a user selection from at least one of suggested surroundings contours or suggested borders.

25. The method of claim 20, wherein the robot is stopped or moved at a changed speed in at least one of the first operating mode or the second operating mode.

26. The method of claim 25, wherein the changed speed is a reduced speed.

27. The method of claim 20, further comprising at least one of:
in response to a collision event, specifying a modified behavior of the robot in at least one of the first operating mode or the second operating mode; or
issuing at least one of an optical warning signal or an acoustic warning signal in response to switching to the first or second operating mode.

28. The method of claim 19, further comprising visually displaying a virtual representation of at least one of the first border or the second border in an augmented reality with the aid of a visualization device.

29. The method of claim 28, wherein at least one of:
the detection device is arranged on the visualization device; or
the method further comprises visually displaying a virtual representation of at least one of the robot or a path of the robot in the augmented reality with the aid of the visualization device.

30. The method of claim 18, wherein at least one of:
the method comprises moving the detection device at least one of translationally, rotationally, or manually relative to the real surroundings; or
the detection device includes at least one of:
at least one contact-free distance measuring meter,
at least one camera, or
an image evaluation device.

31. The method of claim 30, wherein at least one of:
the at least one contact-free distance measuring meter is at least one lidar, at least one radar, or at least one ultrasonic distance meter; or
the at least one camera is a 3D camera system.

32. The method of claim 19, further comprising:
monitoring whether the robot exceeds at least one of the ascertained first border or the ascertained second border based on at least one of detected joint positions or a computer-implemented model of the robot.

33. The method of claim 19, wherein ascertaining at least one of the first border or the second border comprises ascertaining based on at least one three-dimensional geometry primitive that has a specified relation to the first surroundings contour or the second surroundings contour.

34. The method of claim 33, wherein the specified relation to the first surroundings contour or the second surroundings contour is a spatial position.

35. The method of claim 19, wherein ascertaining at least one of the first surroundings contour or the second surroundings contour comprises ascertaining based on at least one of:
the robot, in particular data of the robot detected by the detection device;
a computer-implemented model of the robot; or
a specification by a user of an area of surroundings to be detected.

36. A system for ascertaining at least one border for operating a robot, the system comprising:
a detection device, in particular a mobile or portable detection device, for detecting data of a real surroundings of the robot,
means for ascertaining a first surroundings contour based on the detected data;
means for ascertaining a first border of a first spatial area to be monitored on the basis of this ascertained first surroundings contour;
means for monitoring the robot for exceeding the ascertained first border during operation of the robot; and
means for switching operation of the robot to a first operating mode of the robot in response to a detection that the first border is exceeded.

37. A computer program product comprising program code stored on a non-transitory, machine-readable data medium, the program code configured, when executed by a computer, to cause the computer to:
detect data of real surroundings of the robot using a detection device;
ascertain a first surroundings contour on the basis of the detected data;
ascertain a first border of a first spatial area to be monitored on the basis of this ascertained first surroundings contour;
monitor the robot for exceeding the ascertained first border during operation of the robot; and
switch operation of the robot to a first operating mode of the robot in response to a detection that the first border is exceeded.
